(19) United States
(12) Patent Application Publication
(10) Pub. No.: US 2026/0154740 A1
(43) Pub. Date: Jun. 4, 2026

(54) System and Method for Issuing and Managing Debt-Backed Digital Tokens Pegged to a Fiat Currency on a Blockchain Platform with Optional Dual-Component Architecture, Configurable Buffer Pool Mechanisms, Dynamic Rolling Yield Adjustment, Institutional Repackaging, Bank and Agency Backstop Redemption, Multi-Modal Implementation, Automated Collateral Enforcement, and Asset/Reserve Liquidation

(71) Applicant: Michael Patrick Hogan, Houston, TX (US)

(72) Inventor: Michael Hogan, Houston, TX (US)

(73) Assignee: Michael Patrick Hogan, Houston, TX (US)

(21) Appl. No.: 19/394,470

(22) Filed: Nov. 19, 2025

Related U.S. Application Data
(60) Provisional application No. 63/726,522, filed on Nov. 30, 2024.
(60) Provisional application No. 63/765,595, filed on Mar. 1, 2025.

(51) Int. Cl. G06Q 40/03; H04L 9/00

(52) U.S. Cl. CPC G06Q 40/03; H04L 9/50; H04L 2209/56

(57) ABSTRACT

A blockchain platform issues and manages debt-backed digital tokens pegged to a fiat currency using any tokenized debt or deposit liabilities. Tokens may be minted before debt availability, with proceeds directed to a buffer pool, and may be structured as single- or dual-component tokens enabling institutional repackaging. A yield-bearing component may be pledged, sold, or traded separately. Features include a configurable buffer pool with issuance queuing and proportional bank or agency backstop, dynamic rolling yield with dual-rate publication, automated peg and collateral enforcement, and tokenization of distressed reserves. The platform supports centralized, hybrid, or decentralized implementations and integrates with oracles for market data. Real-time dashboards provide visibility into debt pipelines, market conditions, and regulatory metrics. The system improves stability, efficiency, and scalability in debt tokenization.

### CROSS-REFERENCE TO RELATED APPLICATIONS

This non-provisional application claims the benefit under 35 U.S.C. § 119(e) of U.S. Provisional Application No. 63/726,522, filed Nov. 30, 2024, and U.S. Provisional Application No. 63/765,595, filed Mar. 1, 2025. The entire contents of both provisional applications are incorporated herein by reference in their entirety.

### BACKGROUND OF THE INVENTION

Asset-based lending (ABL) and other debt instruments-including mortgages, automotive loans, credit card receivables, personal loans, commercial loans, accounts receivable financing, and deposit liabilities held by financial institutions-form the foundation of modern credit markets. These instruments require continuous monitoring of collateral, cash flow, reserve levels, lien perfection, repayment schedules, borrowing bases, and regulatory ratios. Conventional systems rely on manual verification, siloed software, and slow reconciliation cycles, generating operational inefficiencies, inconsistent risk controls, and increased costs.

While stablecoins and other digital assets pegged to fiat currencies have emerged, they are generally reserve-backed, not debt-backed, and therefore misaligned with traditional banks'lending-based revenue structure. Tokenizing debt itself—secured or unsecured—creates a new class of debt-backed digital tokens (DBDTs) that reflect bank lending activity and maintain a stable peg. The debt backing DBDTs may be bank liabilities (deposits) or bank assets (loans).

Key challenges include peg stability during supply/demand imbalance, redemption pressure, variable interest rates, debt origination pipelines, collateral deterioration, and distressed asset response. Blockchain and smart-contract automation bring opportunities to (i) tokenize any debt, (ii) automate collateral enforcement, (iii) split tokens into yield and principal components (dual components), (iv) publish dual interest/yield rates, (v) introduce algorithmic buffer pools and backstops, and (vi) liquidate or repackage distressed reserves.

### SUMMARY OF THE INVENTION

The invention provides a unified system for tokenizing any form of debt—secured or unsecured—and issuing digital tokens pegged to a fiat currency (e.g., USD), with optional dual-component separation and a configurable buffer pool for peg maintenance. The system supports centralized, hybrid, or fully decentralized implementations.

Dual-Component Tokens (Optional). Tokens may comprise:
(a) a pegged-value component backed by outstanding tokenized debt or deposit liabilities; and
(b) a yield-bearing component representing interest or yield payable from underlying debt.

The components may be separated, pledged, sold, or hypothecated independently. Banks or exchanges may repackage them as institution-branded instruments.

Debt-Backed Token Framework. Tokens represent aggregate balances of tokenized debt. Minting may occur before debt is available, with proceeds deposited into a buffer pool until suitable debt is matched.

Configurable Buffer Pool. A smart-contract-managed buffer pool issues/mints reserve tokens during demand pressure and absorbs/burns tokens during redemptions. Banks, lenders, insurers, derivatives or agencies may backstop redemptions proportionally against aggregate amounts, when redemptions exceed buffer capacity.

Dynamic Rolling Yield Adjustment. Interest or yields may update periodically (e.g., every 30 days). In a yield adjusting model, two rates are published on-chain: (1) the blended tranche rate; and (2) the current issuance rate. Existing holders maintain prior rates until the next roll.

Automated collateral enforcement and asset liquidation. algorithms may enforce borrowing-base criteria, compel corrective token acquisition, reduction of loan balance, and liquidate collateral or tokenize distressed reserves when thresholds are breached.

Multi-Modal Implementation. The system may operate centrally (off-chain computation oracle with on-chain settlement), in hybrid mode, or as fully decentralized smart contracts on public or private blockchains.

Real-Time Visibility. Dashboards and/or oracle-based feeds show debt pipeline data, borrower ratings or credit scores, market liquidity, redemptions, default scenarios, and regulatory KPIs.

### DETAILED DESCRIPTION OF THE INVENTION

### 1. Tokenization of Debt Instruments

Any debt type may be tokenized, including mortgages, auto loans, credit card balances, receivables, equipment financing, payday loans, student loans, personal loans, deposit liabilities, or corporate ABL structures.

Each debt instrument is represented by a smart contract containing collateral requirements, reserve requirements, rate rules, borrower metadata, and liquidation procedures. Debt balances dynamically adjust token supply via mint/burn rules.

### 2. Dual-Component Token Architecture (Optional) Tokens may be configured as:

(a) a unified token; or
(b) two separable units: underlying pegged-value unit and yield-bearing unit.

Separation allows:
Institutional repackaging (e.g., a branded bank token),
Selling or pledging only the yield component,
Hypothecation without transferring yield rights
Insuring against default of the peg-value unit, and
Custom issuer-specific borrowing-base criteria.

### 3. Expanded Debt and Collateral Backing

Different asset classes may use varying collateralization rates, reserve rates, or seniority structures.

Example: home loans may contribute 50-80% of LTV; credit card receivables may require higher reserve ratios.

### 4. Proprietary Borrowing Base Criteria

Institutions acquiring tokens may define proprietary rules-liquidity ratios, collateral quality, debt-to-equity thresholds, etc. Borrowers failing compliance may be moved to higher-rate tranches or required to purchase additional tokens or reduce their loan balance. 5. Dynamic Rolling Interest/Yield Adjustment

Rates may be recalculated periodically (e.g., 30-day roll).
Existing holders retain their locked rate until roll.
New issuances use the current market rate.
Smart contracts manage timing, application, and distribution.

### 6. Dual Interest/Rate Publication

Two rates are published on-chain per tranche:
(a) blended tranche rate, and
(b) current issuance rate.

### 7. Automated Collateral Enforcement

Smart contracts monitor collateral in real time; violations trigger:
Borrower token acquisition,
Reclassification to higher-rate tranche,
Partial liquidation,
Reduction of the borrower's borrowing base, or
Automatic initiation of asset liquidation.

### 8. Algorithmic Cash Management

Cashflow algorithms buy/sell tokens for borrowers based on borrowing base, liquidity needs, and optimized interest-rate positioning.

### 9. Automated Asset Liquidation and Distressed Asset Tokenization

Upon default, smart contracts seize collateral, liquidate assets, and distribute proceeds. Distressed assets may be tokenized as fractional NFTs or equivalent digital units and sold to recovery firms.

### 10. Automated Interest Distribution

Borrowers maintain an account accessible by smart contracts for automated interest draws. Interest may be tokenized (e.g., in stablecoins) and distributed proportionally to holders.

### 11. Real-time Financial Monitoring

Borrowing-base, collateral valuations, and compliance data are ingested via oracles; smart contracts enforce thresholds continuously or periodically.

### 12. Configurable Buffer Pool and Issuance/redemption Dynamics

The Buffer Pool:
Issues reserve tokens when demand exceeds debt supply;
Absorbs/burns tokens during redemption surges;
Uses bank/agency/insurer backstop proportionally when the pool is insufficient;
Supports queued issuance to prioritize lenders absorbing excess supply of reserve tokens.

### 13. Multi-Modal Implementation

The system may operate:
Centrally (off-chain calculation+on-chain proof),
Hybrid mode, or
Fully decentralized.

### 14. Oracle and Data Integration

Market yields, collateral prices, debt balances, and borrower financials may be provided by price oracles, secure APIs, third-party feeds, or on-chain data.

### 15. Security, Audit, and Traceability

The system uses encryption, multi-factor authentication, immutable ledgers, audit logs, and redundancy. Each token may include metadata or unique identifiers linking it to underlying debt, although due to gas costs and fungibility this may not be the case.

1. A blockchain-based system for issuing and managing debt-backed digital tokens pegged to a fiat currency, comprising smart contracts configured to:
(a) mint tokens independent of immediate availability of underlying debt and direct proceeds into a configurable buffer pool;
(b) subsequently associate tokenized debt with tokens previously held within the buffer pool;
(c) maintain the buffer pool such that reserve tokens are issued during demand pressure and tokens are burned during redemption pressure using first the buffer pool and then bank or agency resources;
(d) provide proportional bank and governmental or non-governmental agency backstop redemption for redemption amounts exceeding buffer pool capacity;
(e) may calculate a dynamic yield on a rolling basis with predefined lock periods for existing holders and publish on-chain both a blended tranche rate and a current issuance rate; and
(f) automatically enforce a fiat peg and, upon default or peg deviation, tokenize and distribute distressed backing reserves.

2. The system of claim 1, wherein the tokens are selectable between a unified single-component token and a dual-component token comprising a separable pegged-value component and a separable yield-bearing component.

3. The system of claim 1, wherein the backing debt comprises customer deposit liabilities of a bank.

4. The system of claim 1, further comprising centralized, hybrid, or fully distributed operational modes selectable by an issuing institution.

5. The system of claim 2, wherein the yield-bearing component is configured for separate sale, pledge, hypothecation, temporary transfer, or permanent transfer.

6. The system of claim 1, wherein the backing debt includes mortgages, automotive loans, credit card receivables, payday loans, asset-based loans, personal loans, or unsecured obligations.

7. The system of claim 1, wherein each token includes metadata or unique identifiers linking the token to an associated debt instrument, debt issuer, or tranche.

8. The system of claim 1, wherein token supply is adjusted via minting and burning at real-time, hourly, daily, or predefined intervals.

9. The system of claim 1, further comprising issuance queuing that prioritizes lenders absorbing excess tokens into savings accounts, certificates of deposit, or liquidity pools.

10. The system of claim 1, further comprising a visibility dashboard or oracle layer showing debt origination pipelines, market activity, default scenarios, and regulatory key performance indicators.

11. The system of claim 2, wherein the yield-bearing component is tradable independently from the pegged-value component on regulated or unregulated secondary markets.

12. The system of claim 1, wherein the buffer pool issues unlimited reserve tokens during demand pressure and purchases and burns tokens during redemption pressure using first the buffer pool and then bank, insurer, or agency resources.

13. The system of claim 1, wherein banks or agencies backstop redemptions proportionally based on issuance share or circulating float.

14. The system of claim 1, wherein the pegged fiat currency is the United States dollar.

15. The system of claim 1, further comprising integration with price oracles for determining market-based yield or current issuance rates.

16. The system of claim 1, wherein yield is determined algorithmically via rolling calculations or directly based on an underlying borrower-lender agreement.

17. The system of claim 1, wherein the predefined lock period is approximately thirty days.

18. The system of claim 1, wherein distressed backing reserves are tokenized as fractional non-fungible tokens or equivalent digital assets for auction or secondary-market distribution.

19. The system of claim 1, wherein the combination of rolling yield adjustment, dual-rate publication, and buffer pool mechanisms reduces fiat-peg volatility relative to reserve-backed stablecoin systems.

20. A method comprising performing, by one or more smart contracts on a blockchain, the operations recited in claim 1.
